(19) United States
(12) Patent Application Publication
(10) Pub. No.: US 2009/0282054 A1
(43) Pub. Date: Nov. 12, 2009

(54) IDS Reference Tracking System

(76) Inventor: Michael R. Casey, Dunn Loring, VA (US)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 11/865,608

(22) Filed: Oct. 1, 2007

Related U.S. Application Data
(60) Provisional application No. 60/847,998, filed on Sep. 29, 2006.

(51) Int. Cl. G06F 17/30

(52) U.S. Cl. 707/100; 707/E17.01

(57) ABSTRACT

A computer system can be utilized to track information about patent cases and the references that have been and will be cited therein. After bibliographic information about at least one application or patent has been entered, the references that have been submitted (and when they were submitted) as well as the references that have been considered by the examiner can be associated with the applications. Similarly, references that are to be submitted in the future can be cited associated with the application(s) as well. Data about previously issued patents can also be imported (e.g., from a computer clipboard or an XML file) to help populate the system data repository with historical information. Information from PAIR can be downloaded or imported to further populate the system data repository with historical information.

### CROSS-REFERENCE TO CO-PENDING APPLICATIONS

The present invention claims priority to co-pending U.S. Patent application 60/847,998. The entire contents of those applications are incorporated herein by reference.

### RESERVATION OF COPYRIGHT RIGHTS

A portion of the disclosure of this patent docu-ment contains material which is subject to (copy-right or mask work) protection. The (copyright or mask work) owner has no objection to the facsimile reproduction by anyone of the patent document or the patent disclosure, as it appears in the Patent and Trademark Office patent file or records, but other-wise reserves all (copyright or mask work) rights whatsoever.

### FIELD OF INVENTION

The present disclosure is directed to an reference tracking system for Information Disclosure Statements (IDSs) which can be used to help cite prior art to Patent Offices (foreign and domestic), and in one embodiment to a computer program product which causes a processor to cross-cite references and print IDS forms for submission to the appropriate Patent Office.

### DISCUSSION OF THE BACKGROUND

Information disclosure statements are currently an integral part of the patent system in the United States Patent and Trademark Office. However, as a number of applications (both foreign and domestic) that are filed on behalf of a related set of inventors increases, so does the complexity of keeping track of which references cited in those applications need to be cited in which other cases. A significant impediment to being able to track relevant references is the need for a historical data that often is not in a form that can be easily imported into a tracking program by unsophisticated users.

### BRIEF DESCRIPTION OF THE DRAWINGS

The following description, given with respect to the attached drawings, may be better understood with reference to the non-limiting examples of the drawings, wherein:

FIG. 1 is a screen capture of an exemplary interface for tracking references that have and will be cited in a series of specified cases;

FIG. 2 is a screen capture of an exemplary interface for tracking references that have and will be cited in a series of applications for a set of test data representing a number of patent applications;

FIG. 3a is a screen capture of an exemplary interface for tracking the bibliographic information about a set of applications;

FIG. 3b is a screen capture of an exemplary interface for entering data about new dockets such that the data is available to an interface such as shown in FIG. 3a;

FIG. 4a is a screen capture of an exemplary interface for tracking information about inventors of a set of applications;

FIG. 4b is a screen capture of an exemplary interface for entering data about new inventors such that the data is available to an interface such as shown in FIG. 3a;

FIG. 4a is a screen capture of an exemplary interface for tracking information about inventors of a set of applications;

FIG. 5 is a screen capture of an exemplary interface for tracking information about which cases, if any, in a set of applications should be treated as related to each other;

FIG. 6 is a screen capture of an exemplary interface for identifying which references in the list(s) should be cited in which applications;

FIG. 7 is a screen capture of an exemplary interface for adding US patent references to the data that is tracked by the system and for editing information about the US patent references;

FIG. 8 is a screen capture of an exemplary interface for adding foreign patent references to the data that is tracked by the system and for editing information about the foreign patent references (including where a scanned copy of the reference(s) can be found);

FIG. 9a is a screen capture of an exemplary interface for adding non-patent references to the data that is tracked by the system and for editing information about the non-patent references (including where a scanned copy of the reference can be found);

FIG. 9b is a screen capture of the interface of FIG. 9a along with a context specific menu that enables non-patent references to be manipulated;

FIG. 10a is a screen capture of an exemplary interface for indicating which previously filed information disclosure statement was considered by the examiner such that those references can be tracked as considered;

FIG. 10b is a screen capture of an exemplary interface for performing operations (e.g., duplicating an IDS into another case) related to submitted (or generated) IDSs;

FIG. 11 is a screen capture of an exemplary interface for tracking information about a case and a scanned copy of the corresponding document;

FIG. 12 is a screen capture of an exemplary interface showing that information about cited references can be imported from a clipboard and information about a case can be exported to the clipboard;

FIG. 13 is a screen capture of a menu showing the kinds of reports that can be generated in order to help track references to be cited; and

FIG. 14 is a screen capture of an exemplary interface showing that information can be collected from the clipboard and formatted into columns that can then be mapped to the various bibliographic fields for references;

FIG. 15 is a screen capture of an exemplary interface showing that information that is imported from the clipboard can be directly copied to the interface for adding references to cases;

FIG. 16 is a screen capture of an exemplary interface showing that information added from the clipboard can be used to populate data about references (e.g., the bibliographic information about US patent publications, foreign patents, etc.); and

FIG. 17 is a screen capture of an exemplary interface for importing case-specific information from the PAIR system to aid in entry of historical docket information.

### DISCUSSION OF THE PREFERRED EMBODIMENTS

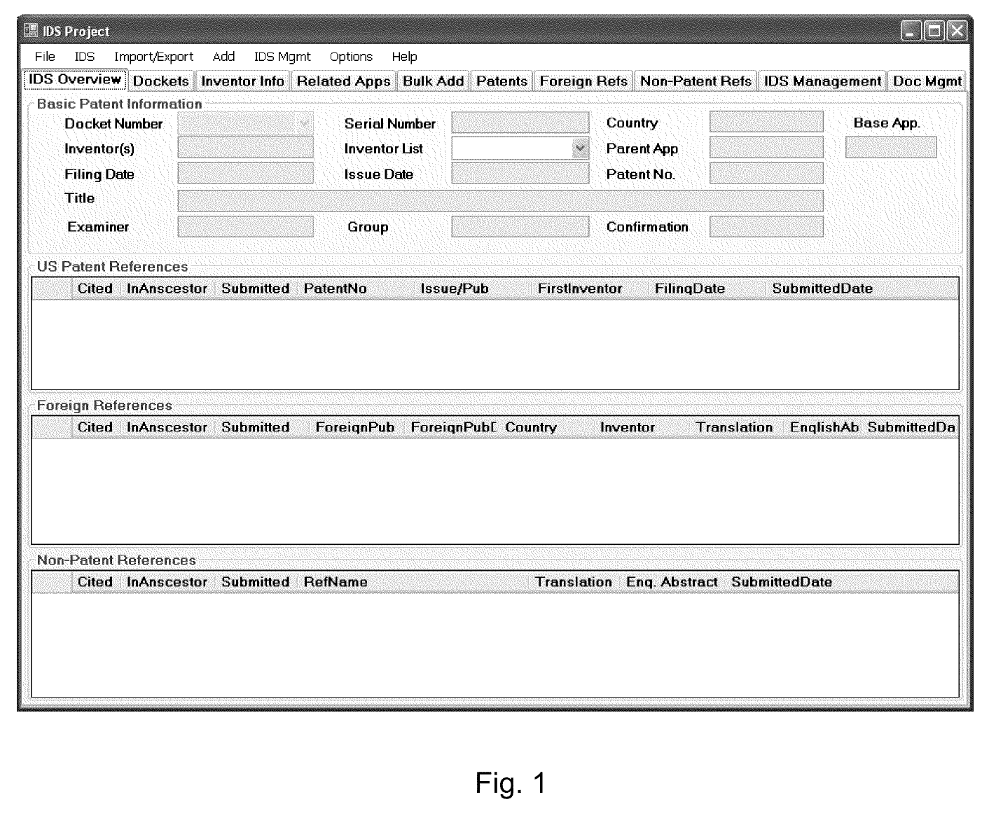

As shown in FIG. 1, a computer system can be utilized to track information about patent cases and the references that have been and will be cited therein. As shown in FIG. 1, the data repository of the system can initially be completely empty, or the system could be preloaded with other data (e.g., bibliographic data about previously issued patents and previously published applications).

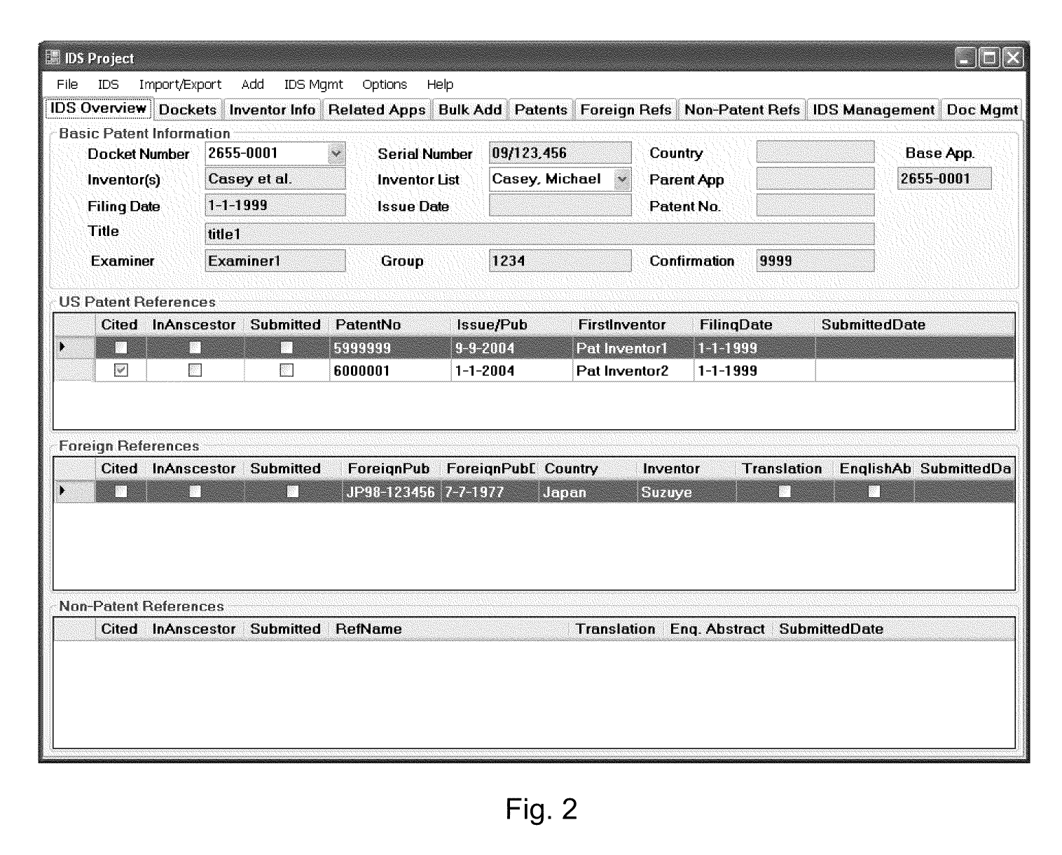

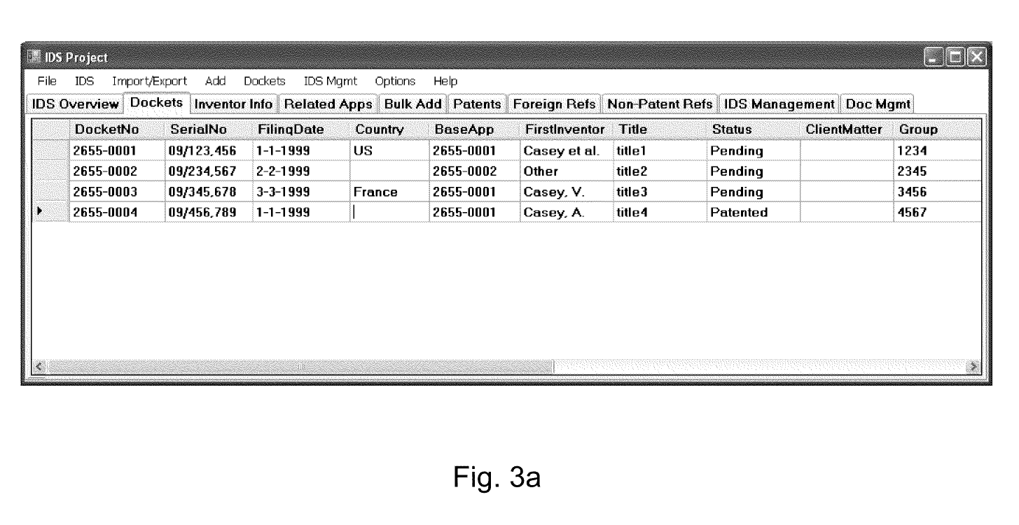

As shown in FIG. 2, after bibliographic information about at least one application or patent has been entered, the references that have been submitted (and when they were submitted) as well as the references that have been considered by the examiner (labeled as “cited”) can be associated with the applications. Similarly, references that are to be submitted in the future can be cited associated with the application(s) as well. As shown in FIG. 2, two different IDSs have been submitted for the exemplary case—the first on Mar. 14, 2007 and the second on Mar. 15, 2007. There is also a single patent (i.e., U.S. Pat. No. 6,000,001) that was previously considered (having been found by the examiner or the applicant).

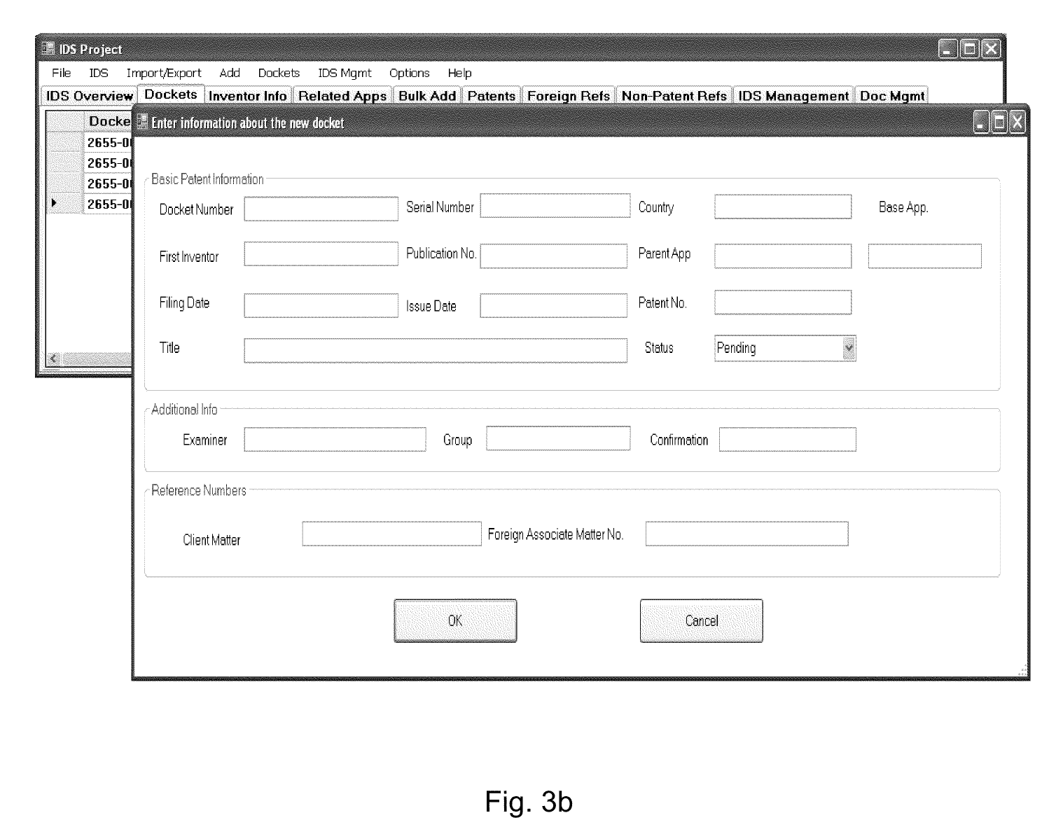

As shown in FIG. 3a, the system can provide an interface for editing the information about cases tracked by the system. For example, as a serial number becomes known for a case, the serial number can be edited. Likewise, the status of the case may be edited to reflect pending versus patented versus abandoned applications. Other information, such as the confirmation number may be tracked. All or some portion of this information can be exported to the clipboard so that document headers on amendments and filing receipts can be filled out with information from the system, as shown in FIG. 12.

FIG. 3b shows that an additional screen may be used to add new applications to the data tracked by the system.

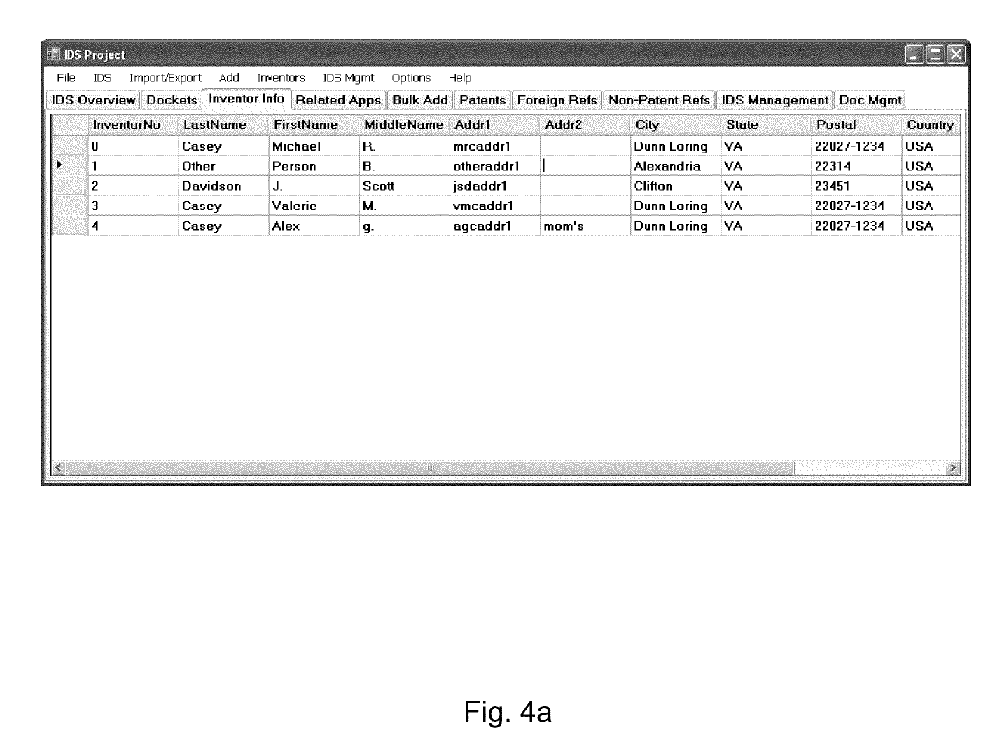

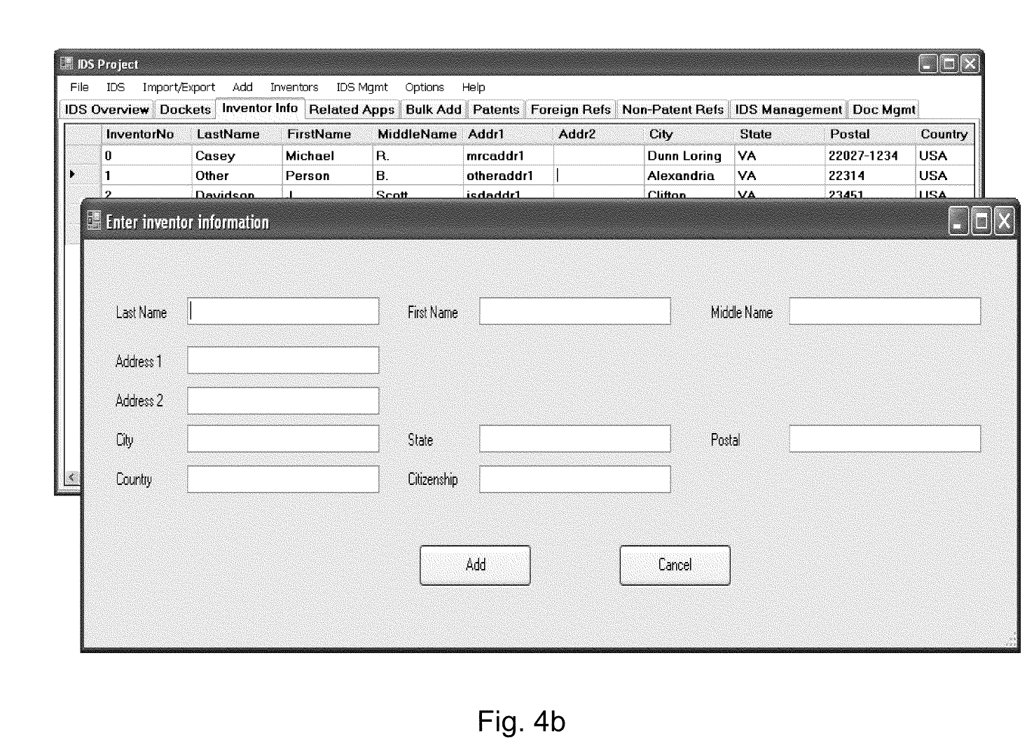

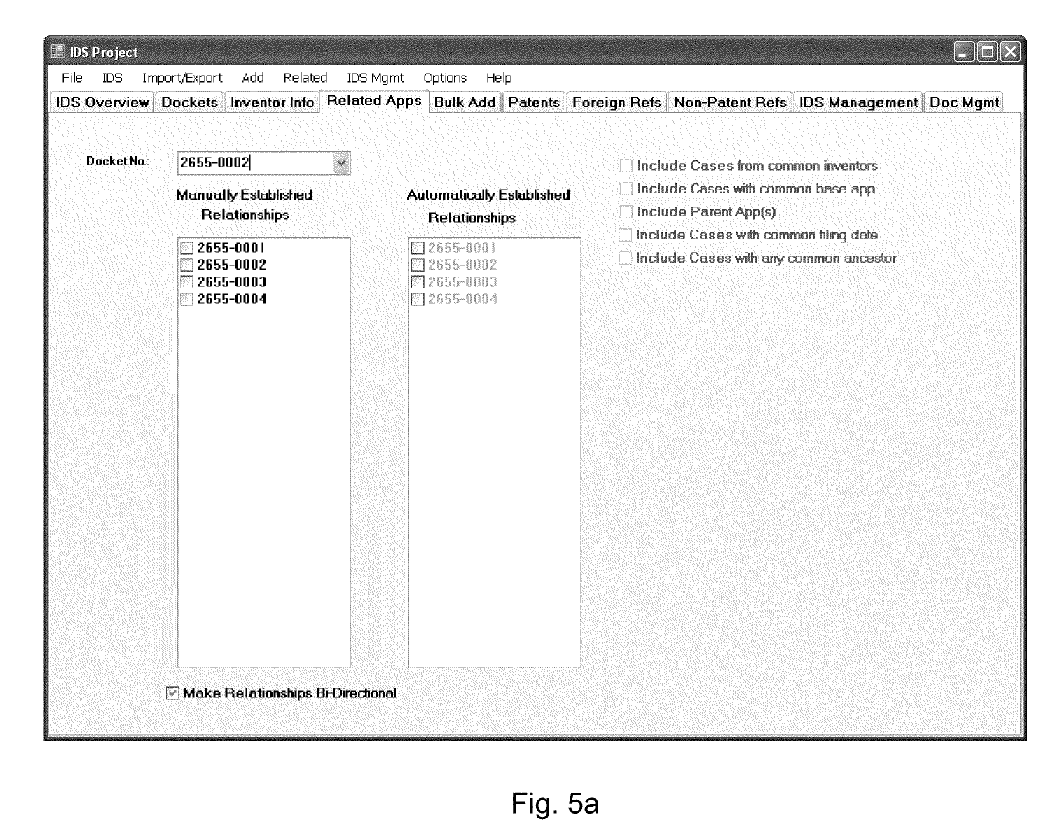

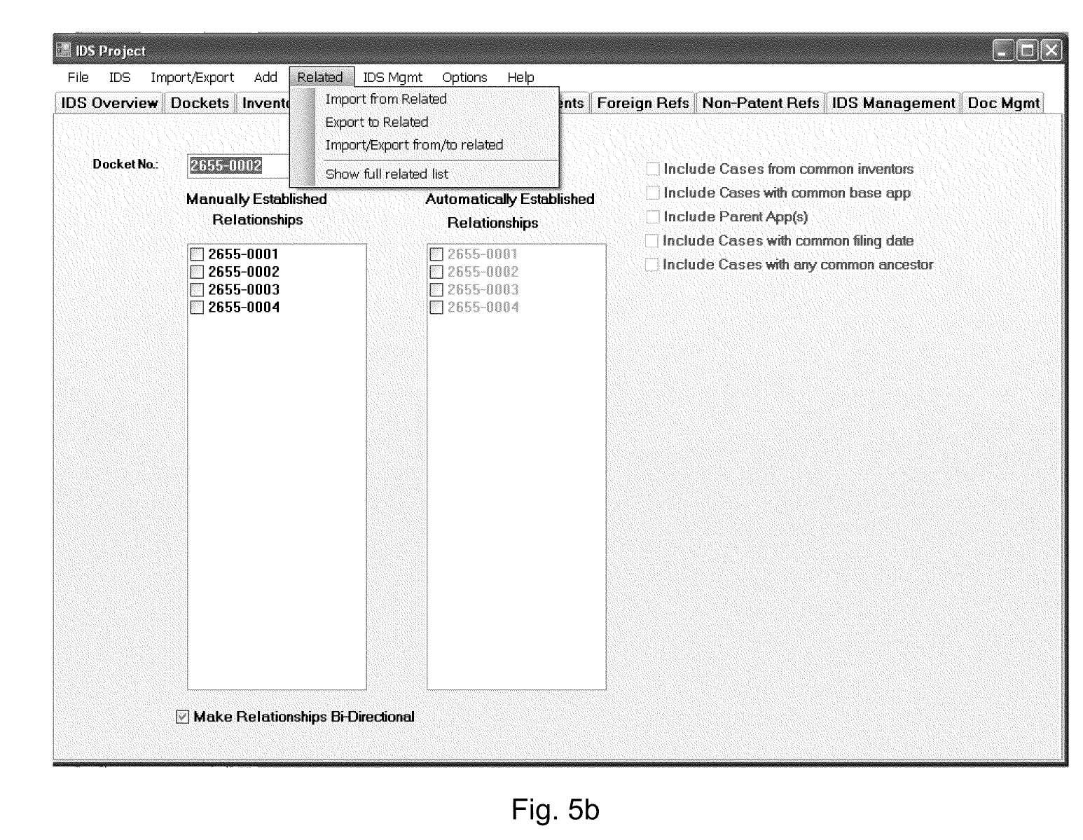

As shown in FIG. 4a, the system can provide an interface for editing information about inventors. As shown, inventors are assigned a unique inventor ID to distinguish between two inventors that might have the same name. By including the inventor ID, the system can quickly mark as related all applications sharing a common inventor, as shown in FIG. 5. FIG. 4b shows that an additional screen may be used to add new inventors to the data tracked by the system.

As shown in FIG. 5a, an application may be set to be related to other applications tracked. by the system either using manual relationships or by using programmatic relationships. As illustrated, the five programmatic relationships (each with a corresponding checkbox to its left) are “Include cases from common inventor”, “Include cases with common base application”, “Include parent application(s)”, “include cases with common filing date” and “include cases with any common ancestor”. By selecting any of the checkboxes, the corresponding condition is evaluated by the system and the corresponding applications become related. The relationship can be seen visually by one or more of the checkboxes in the “Automatically Established Relationships” listbox becoming checked (or unchecked if the relationship is turned off). Using the data of FIG. 3a, if docket number “2655-0003” were selected, it would be possible to select “Include cases with common base application” because the system has been told that “2655-0001” is the base case for “2655-0003”. This can be useful if there are many applications (e.g., foreign and domestic) that relate to the same base application.

As shown in FIG. 5b, the references that have been cited in the displayed current case (shown as “2655-0002”) can be pushed to the other related applications by selecting “Export to related”. Similarly, references from related can be pulled into the displayed current case by selecting “Import from related”. Both processes can be performed by selecting “Import/export from/to related”. The system can also identify for the user all the related cases by “traversing the tree” of related cases. For example, if case A is related to case B and case B is related to case C, then the system can show that case A is really related to cases B and C, even though there is no direct manual or automatic relationship.

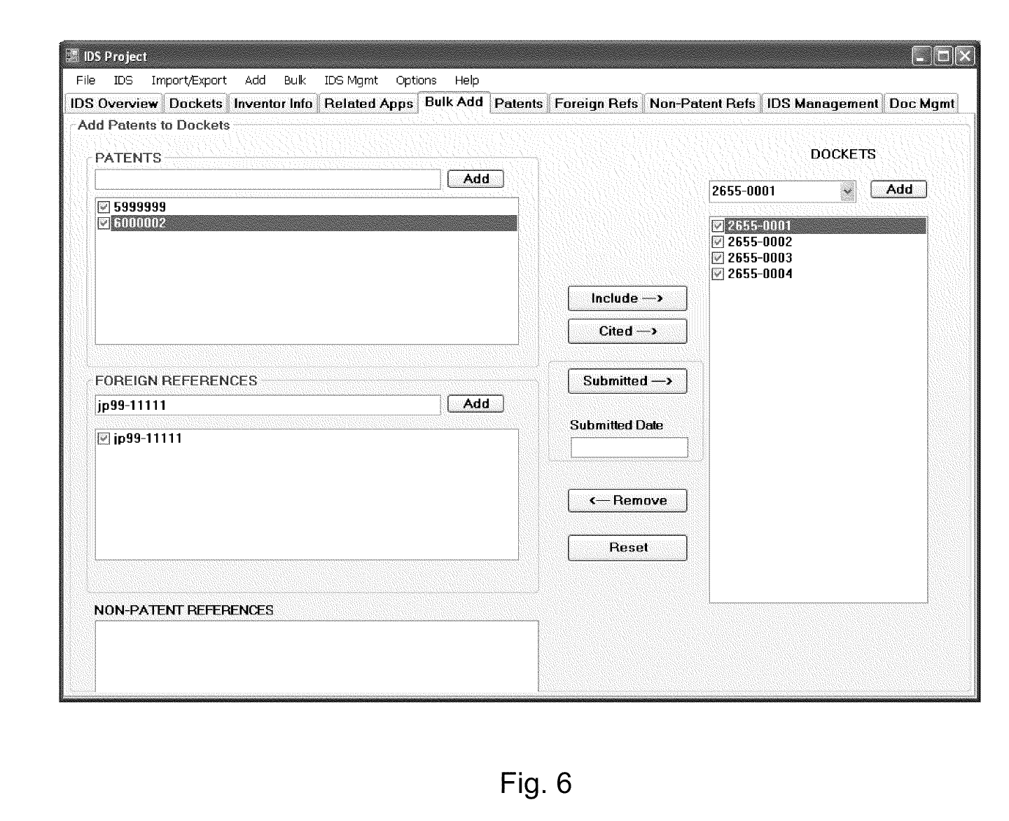

As shown in FIG. 6, since the system may be used with large amounts of historical data, it may be helpful to include a screen that provides the ability to gather a series of references before selectively adding them to various cases. As shown, references (e.g., patents foreign references and non-patent references) can be added manually, using their corresponding “Add” buttons, and dockets can be added as well. Then, all the references with checked checkboxes can be added to all the dockets with checked checkboxes. They can be added as submitted, cited (or considered) or neither, using the “Submitted”, “Cited” and “Include” buttons, respectively. Also if a reference was inadvertently added to the wrong docket, it can be removed using the “remove” button.

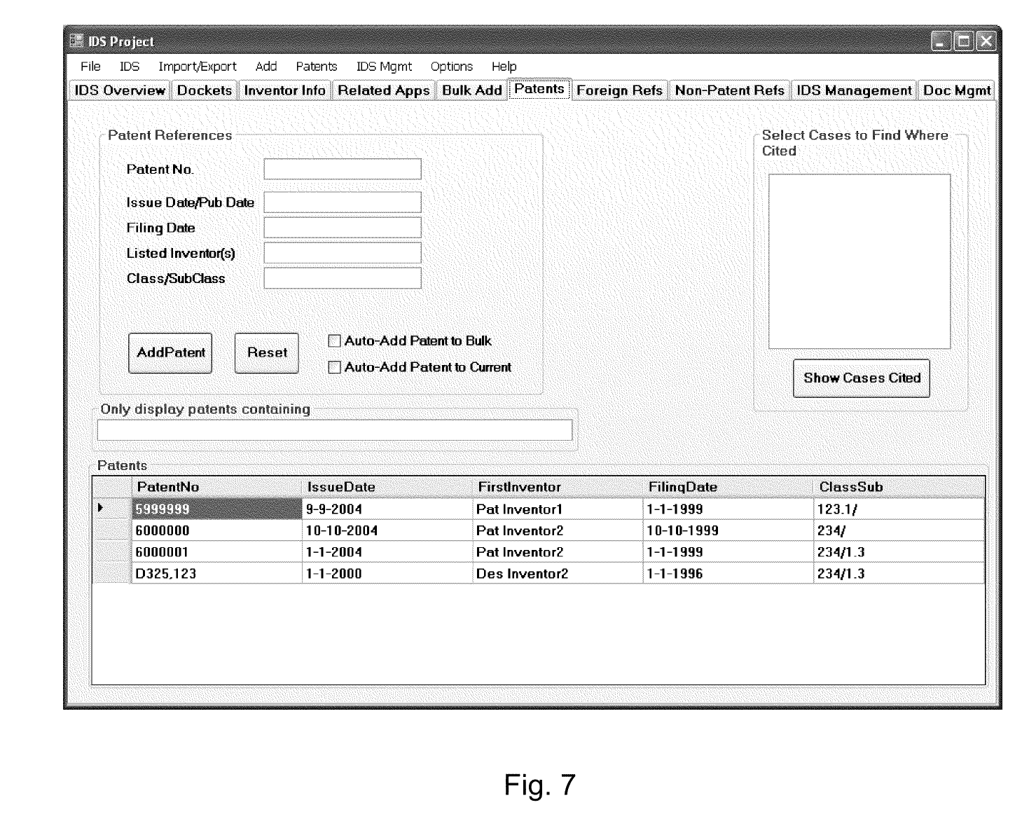

As shown in FIG. 7, the system may have US patents and publications added to it with the bibliographic information that corresponds to those publications. To facilitate adding the information to historic cases, the user can select “Auto-add Patent to Bulk” so that it is automatically added to an interface such as was discussed with reference to FIG. 6. Similarly, the user can instruct the system to automatically add the patent to the docket that is currently being worked on so, for example as one might do when adding a previously pending application to the system. The system may also identify for a user in which dockets a particular case has been cited by selecting the corresponding table entry and pushing the “Show Cases Cited” button. The table further may allow editing of the information about a patent, for example if the patentee's name was misspelled.

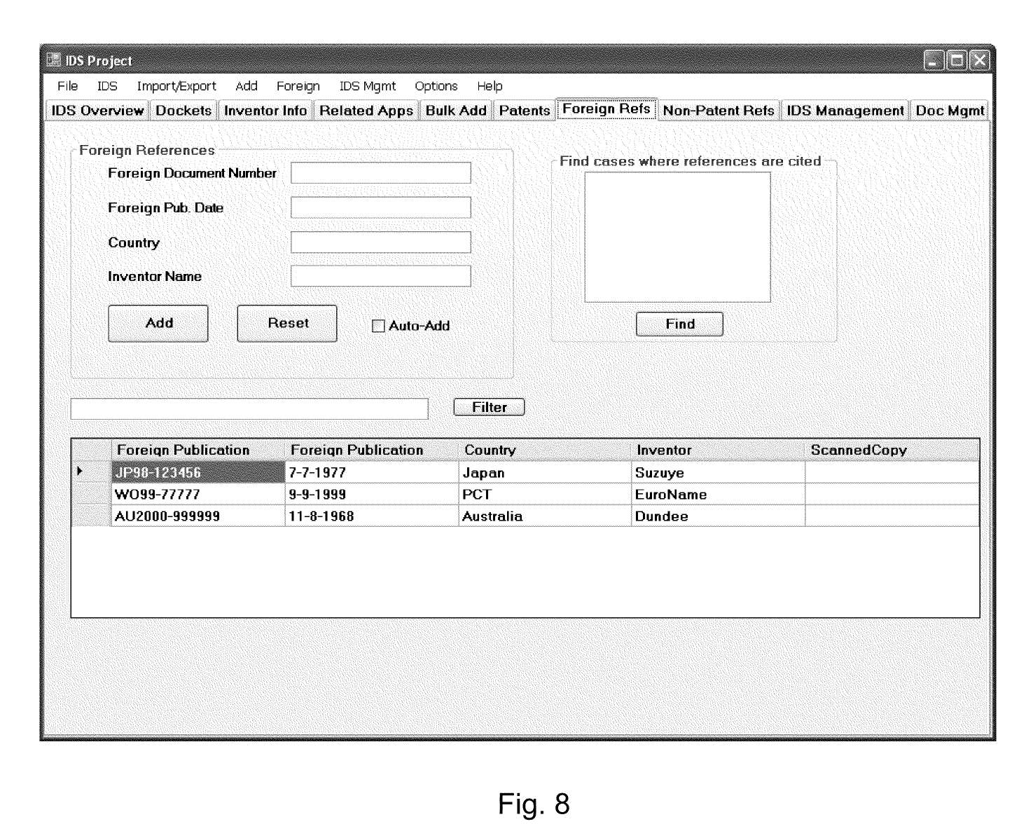

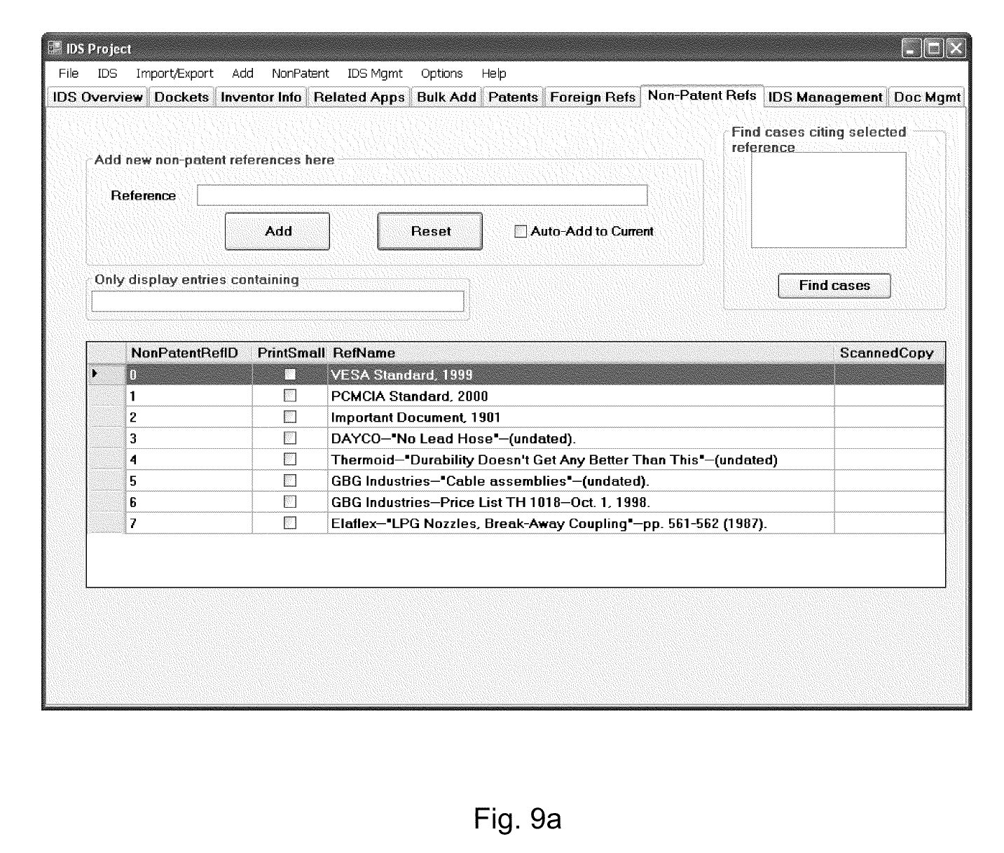

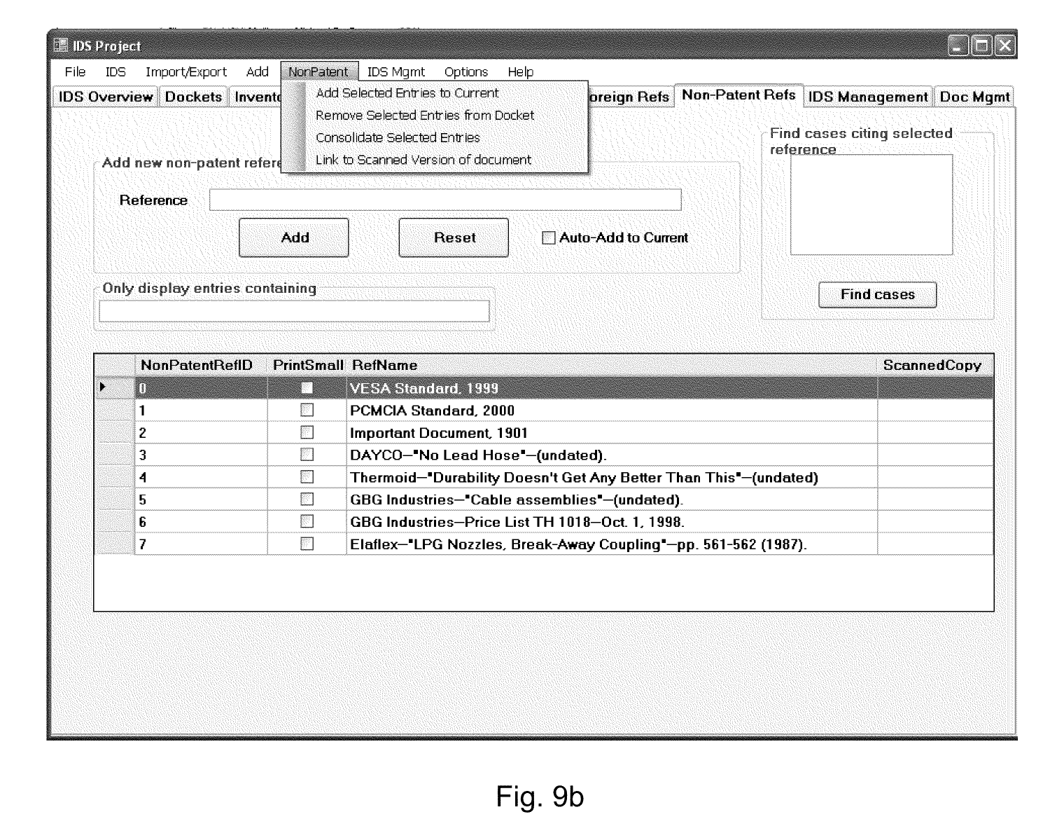

As shown in FIGS. 8 and 9a, a similar interface may be used for adding and modify information related to foreign patents and non-patent references. Since it may be difficult to match some foreign reference names to the corresponding document, the system may further allow a foreign or non-patent reference to be linked to the corresponding entry in the table. For example, a user may double click on the “ScannedCopy” column in the table to be prompted to enter the location of the scanned file (or to be provided with a dialog box interface for selecting the corresponding file from a local or remote directory). The user may further be able to open a scanned copy (e.g., using an ADOBE READER document reading program) by selecting a menu item or clicking on an appropriate portion of the entry with the appropriate mouse button.

As shown in FIG. 9a, the non-patent references are assigned unique identifiers as well since multiple documents may include the same name. There is additionally illustrated a filter box which causes only references that contain the string entered in the filter to be shown. This helps to determine if an entry already exists before adding it. Because two entries that rally reference the same non-patent reference may inadvertently be added to the system twice, as shown in FIG. 9b, the system may allow two or more references to be consolidated into a single new master reference for future citations. If any of the references being consolidated have previously been cited or submitted, then the data entry for the master record is updated to reflect the appropriate status. For example, if the non-patent reference has been considered under any of its various names, then it is marked as cited. Otherwise, if the non-patent reference has been submitted under any of its various names, then the new master record should reflect when it was submitted.

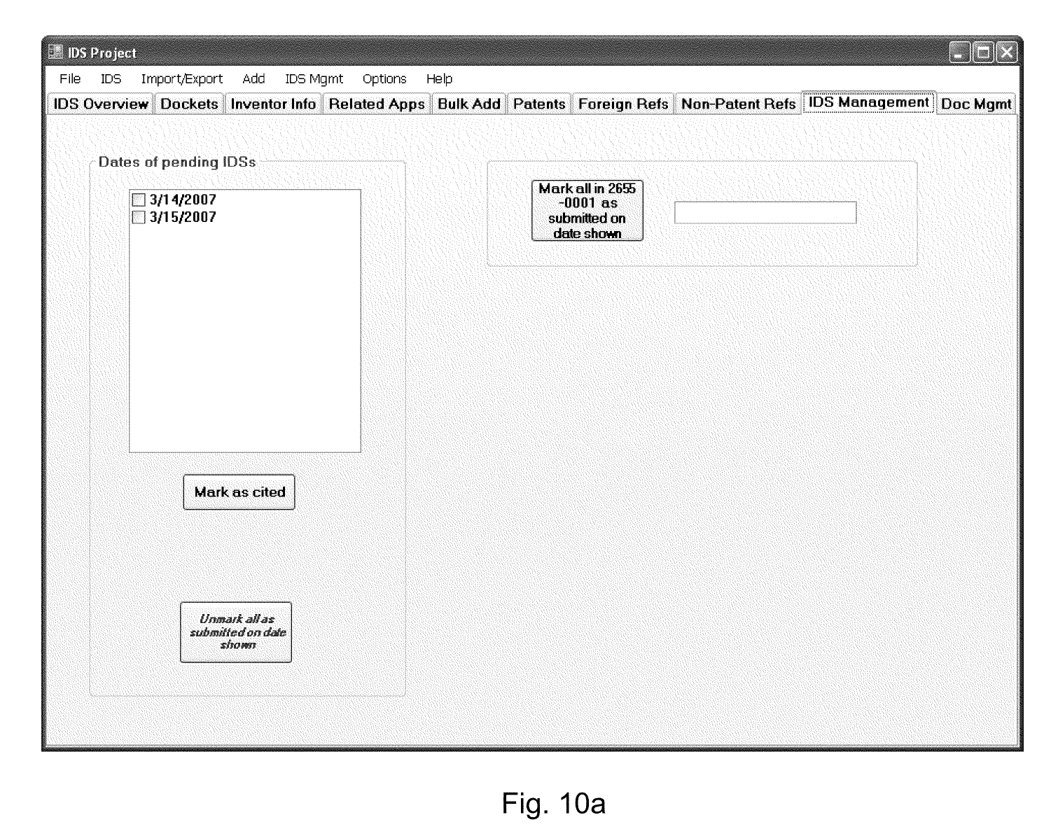

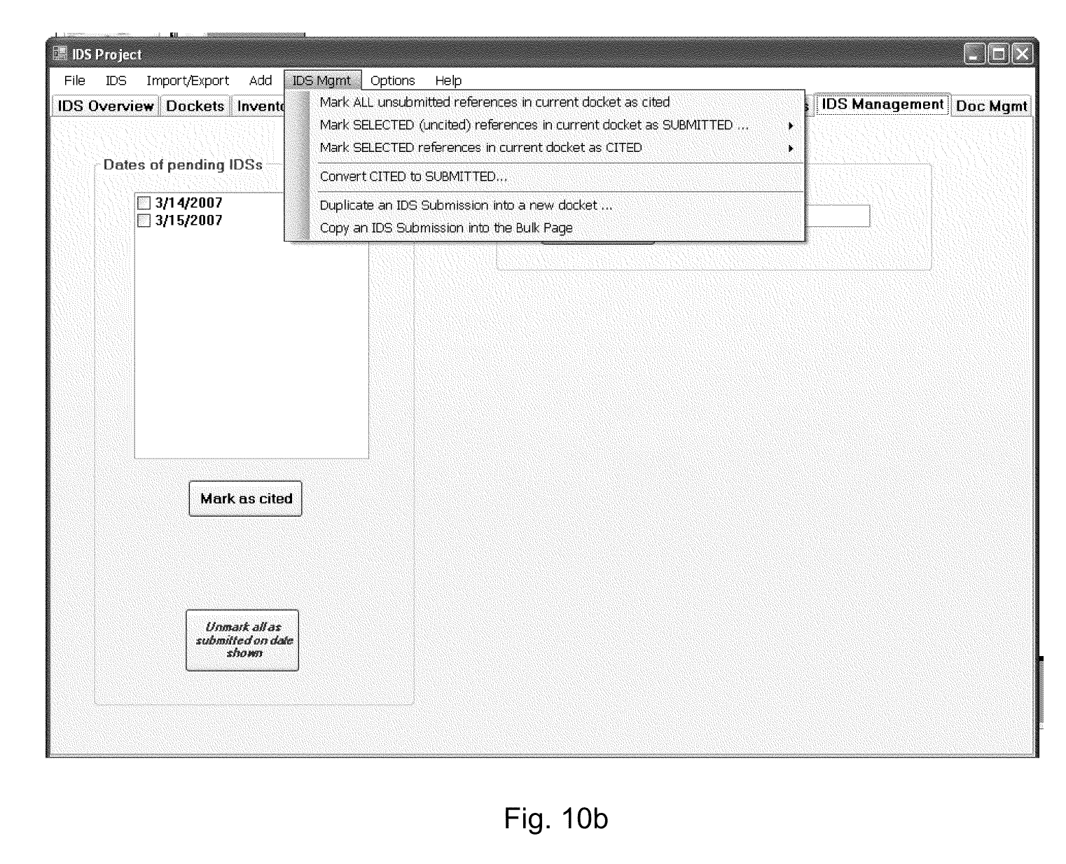

Once an IDS has been generated and submitted, the system tracks, on a case-by-case basis, which IDSs are still awaiting consideration by the examiner. As shown in FIG. 10a, the list of pending IDSs can be displayed in a list, and all the corresponding references cited therein can be marked as considered (or cited) by selecting the “Mark as cited” button. References that were previously submitted before utilization of the system described herein may be marked as submitted by selecting the “Mark all” button. It may also be necessary to “unmark” references as having been cited if, for example, an IDS was not filed after being generated because an error was found in the list.

As shown in FIG. 10b, IDSs may also be added to the bulk page of FIG. 6, for example, if a user is going to duplicate all or most of one IDS in another case. When IDSs are exactly the same, the user can select “Duplicate an IDS Submission into a new docket” and be prompted for the docket number.

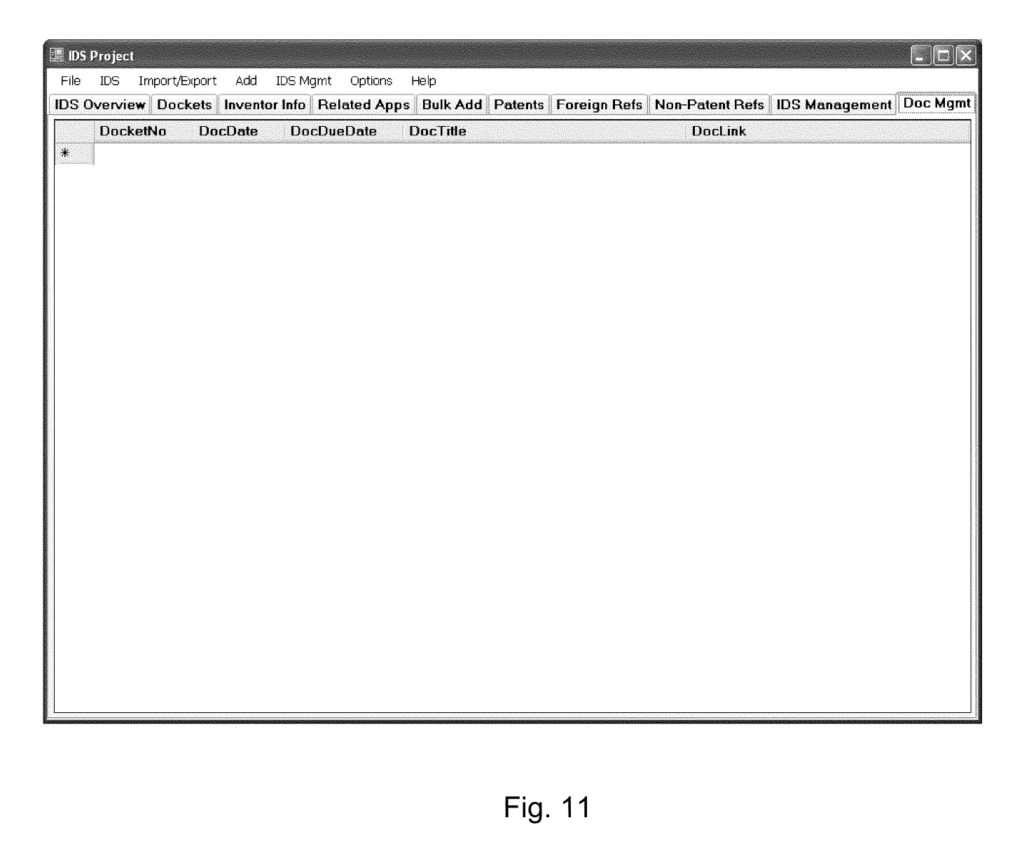

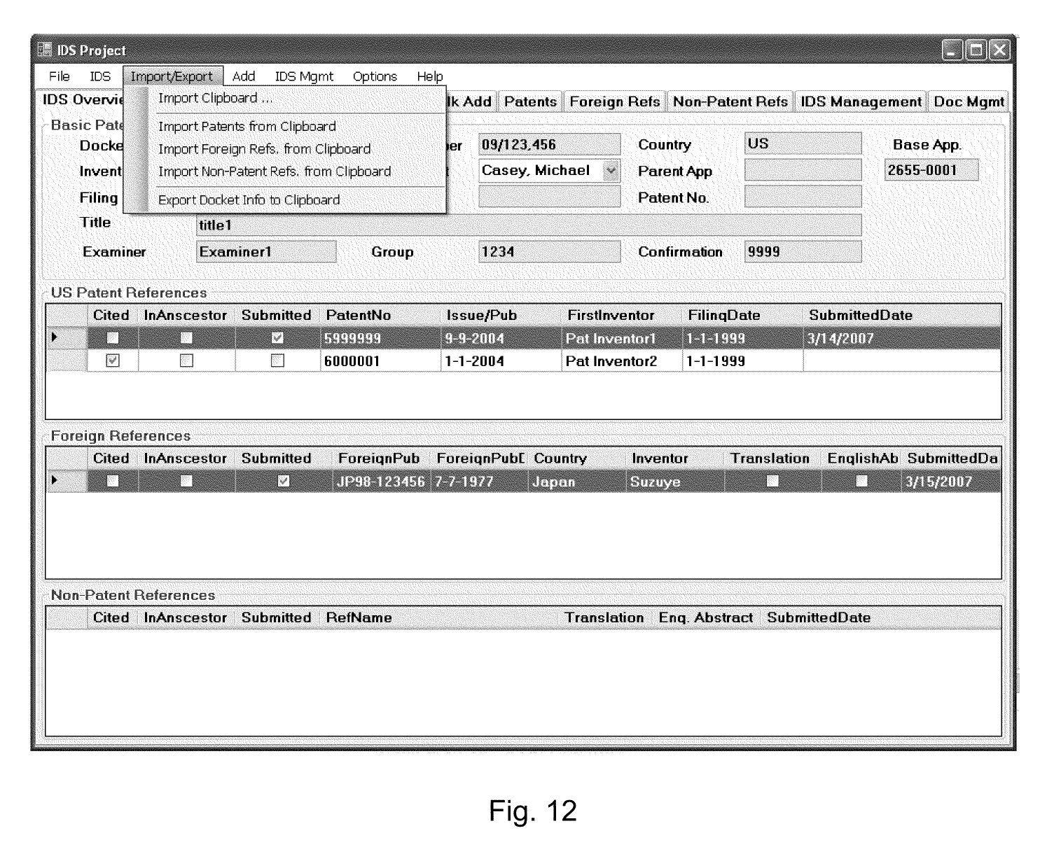

FIG. 11 shows that the same system can track other relevant documents, such as office actions, and provide links to them for easy reference. As described herein, only the link is stored, and the actual scanned file is stored at the location specified in the link. This keeps down the size of the information repository. However, this can lead to links being “stale” such that the corresponding file is moved. In an alternate embodiment, the actual reference is stored in the repository as well.

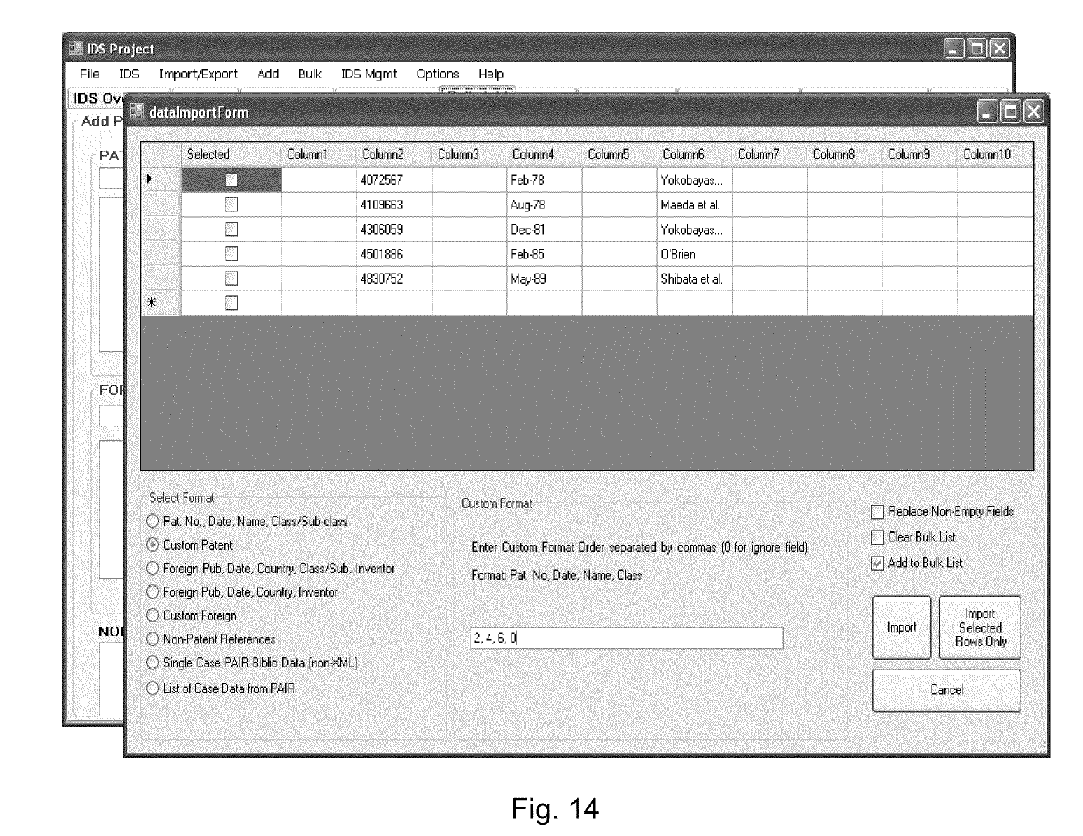

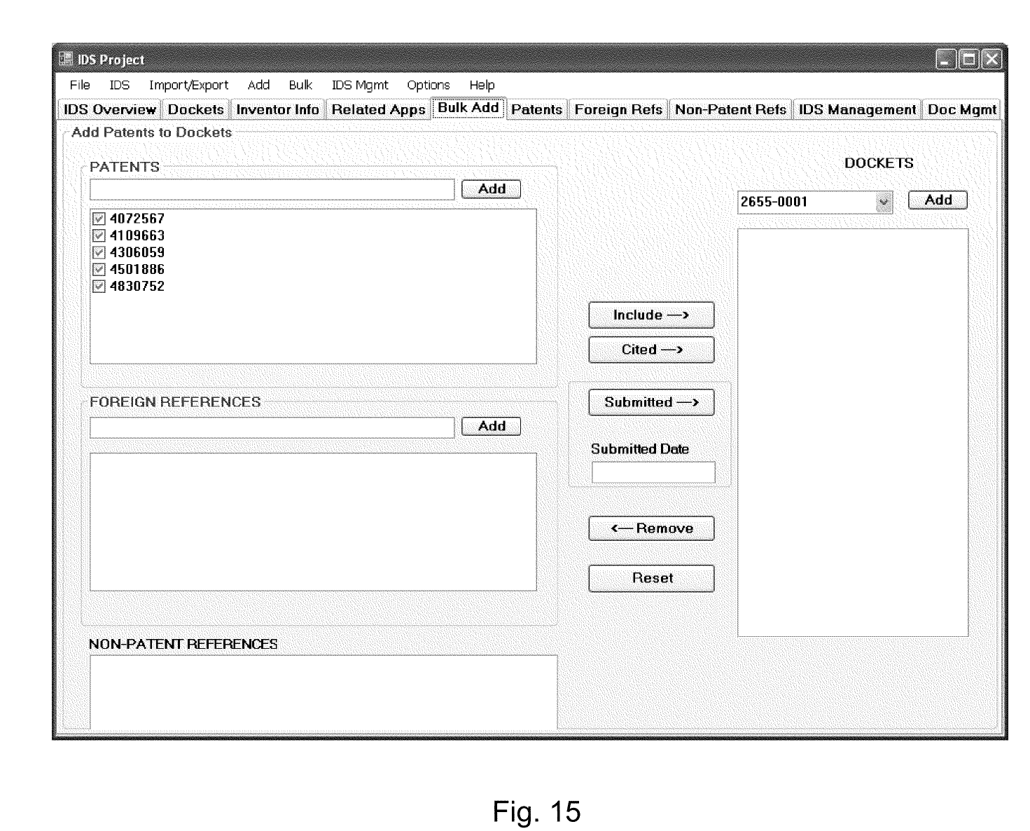

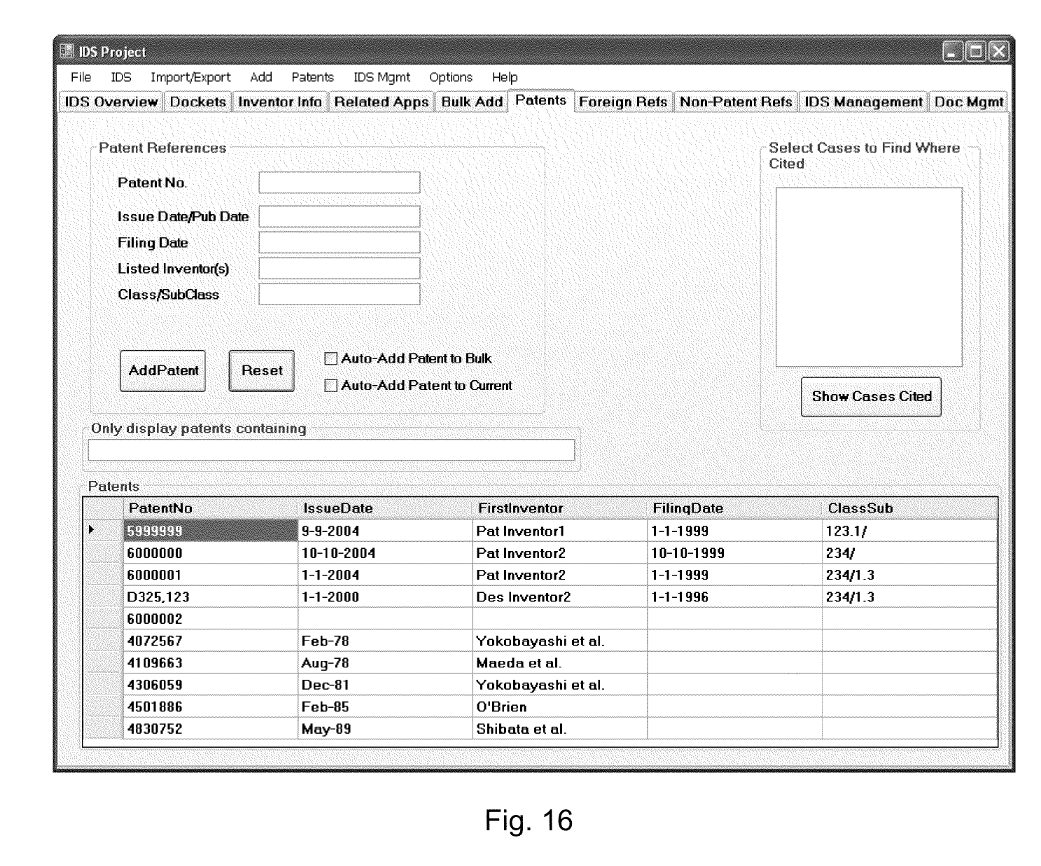

As shown in FIG. 12, it is possible to import information about cases from a number of sources. One such source is the clipboard. As shown in FIG. 14, the clipboard can act as columns of data whose meaning is assigned when the data is imported. This allows a source of historical information, such as web-versions of printed patents, to have data copied therefrom and then imported from the clipboard, either in a standard format or a custom format where the field is dynamically mapped to a column of data. As shown in FIG. 14, data copied from a web browser viewing U.S. Pat. No. 7,000,000 is to be imported. By selecting “Custom patent” the system can then specify that columns 2, 4 and 6 have the associated patent number, date and name information. that is to be imported. The information can. be imported into the patent information or into the patent information and the bulk data entry interface of FIG. 6. Similarly, either all the rows or just selected rows can be imported. FIG. 15 shows a bulk add interface that was cleared prior to importing the data of FIG. 14. FIG. 16 shows that the patents imported as part of FIG. 14 are reflected in the list of patents (as compared to FIG. 7).

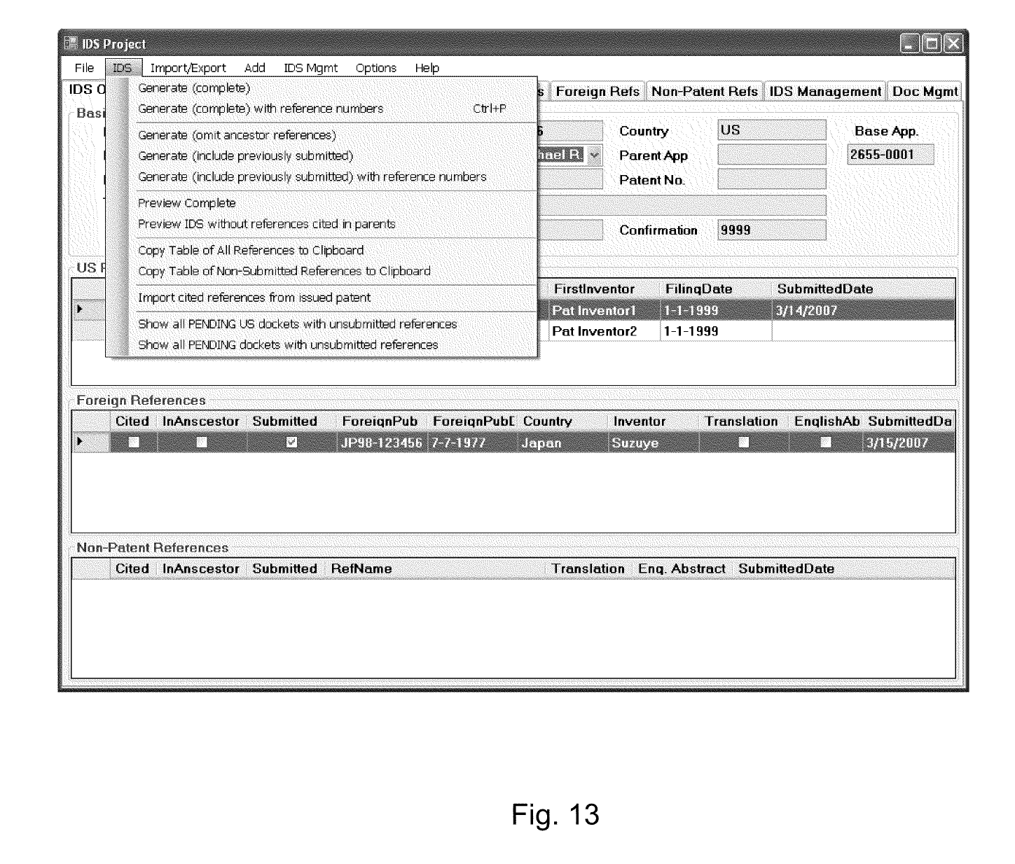

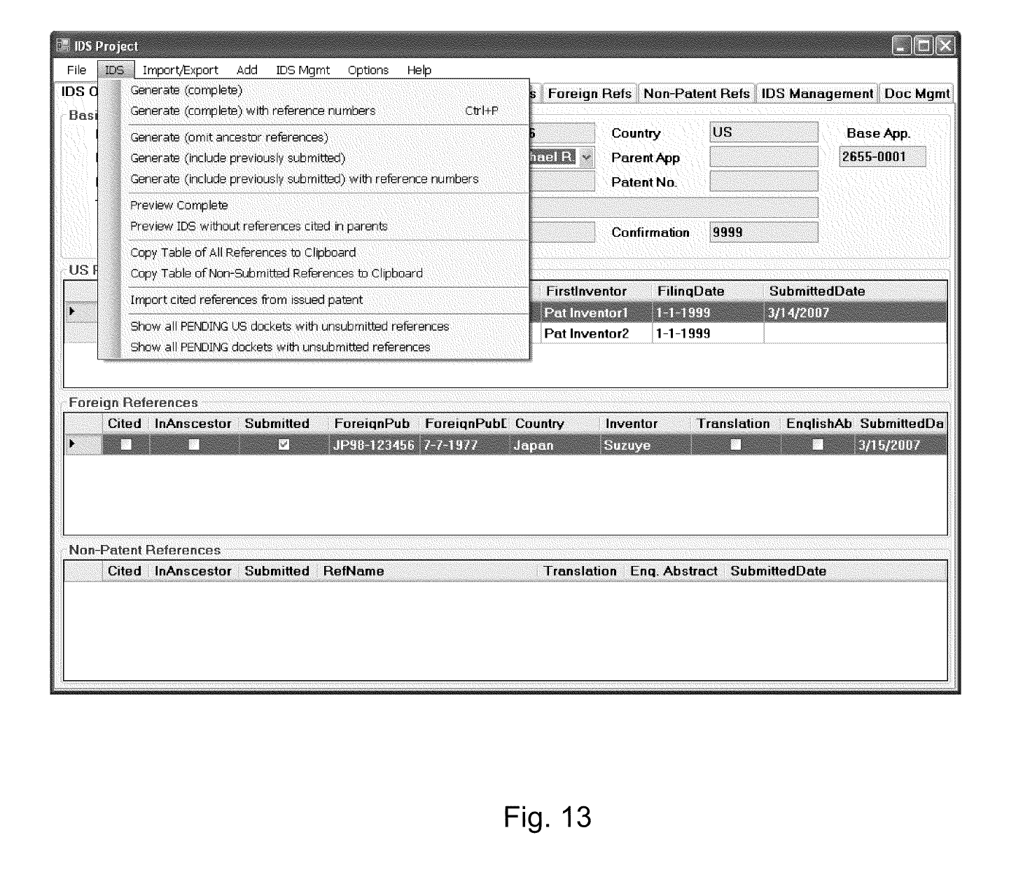

As shown in FIG. 13, a number of IDS reports can be generated. For example, a report can be run (and the system updated to reflect the current date as the submission date) or a report preview can be run so that the data can be checked before updating the system's data repository. Reference numbers can be added to the IDS and references previously submitted or considered in the parent application can be included or omitted.

Since some other countries may request a list of the references cited in the US or other cases, it may be possible to copy to the clipboard all reference or all references that were not previously submitted. The system may also be asked to identify all pending applications that have unsubmitted references so that IDSs can be run for those dockets. If only US cases are to be considered, then a different menu item can be selected.

While the incorporated code in the attached computer listing implements an exemplary system for tracking references (e.g., U.S. patents, U.S. applications, foreign patent references and non-patent references) and printing them, other systems are possible without departing from the scope of the present disclosure. For example, while the code utilizes a file as the information repository, other information repositories, such as a database, can be used instead.

In one embodiment, the system allows users to enter bibliographic information about a case (e.g., docket number, serial number, etc.) and then associate with that information the references that have been cited or should be cited. Information on what references have been cited or should be cited can be entered manually, received from the clipboard, or dragged-and-dropped. In one such embodiment, the information can be copied or dragged from a web-version of an issued patent or a patent application having at least one known format such that data entry is reduced. Additionally, currently the patent office publishes bibliographic information about issued patents and published applications in XML format. A system as described herein may be programmed to read such historical data and parse it to extract bibliographic information so that the user does not have to retype it. For example, the data about a week's publications and issuances can be parsed so that the patent number (or publication number) date, name, etc. can be added to the system. Then the user can simply add patents through the bulk interface by patent number and the remainder of the information is read from the parsed data. Similarly, since the published data also includes the references that were considered in the corresponding patent, a historical list of patents can be created by aggregating the bibliographic information about any patent cited during prosecution of that week's patents. For example, by parsing the data for the week that U.S. Pat. No. 7,000,000 was issued, the bibliographic information about the five patents listed in FIG. 14 can be obtained, even if the patent office does not publish data back far enough to cover, for example, U.S. Pat. No. 4,072,567. Thus, rather than having to cut-and-paste from web-published patents, the system could instead parse files to determine the same information.

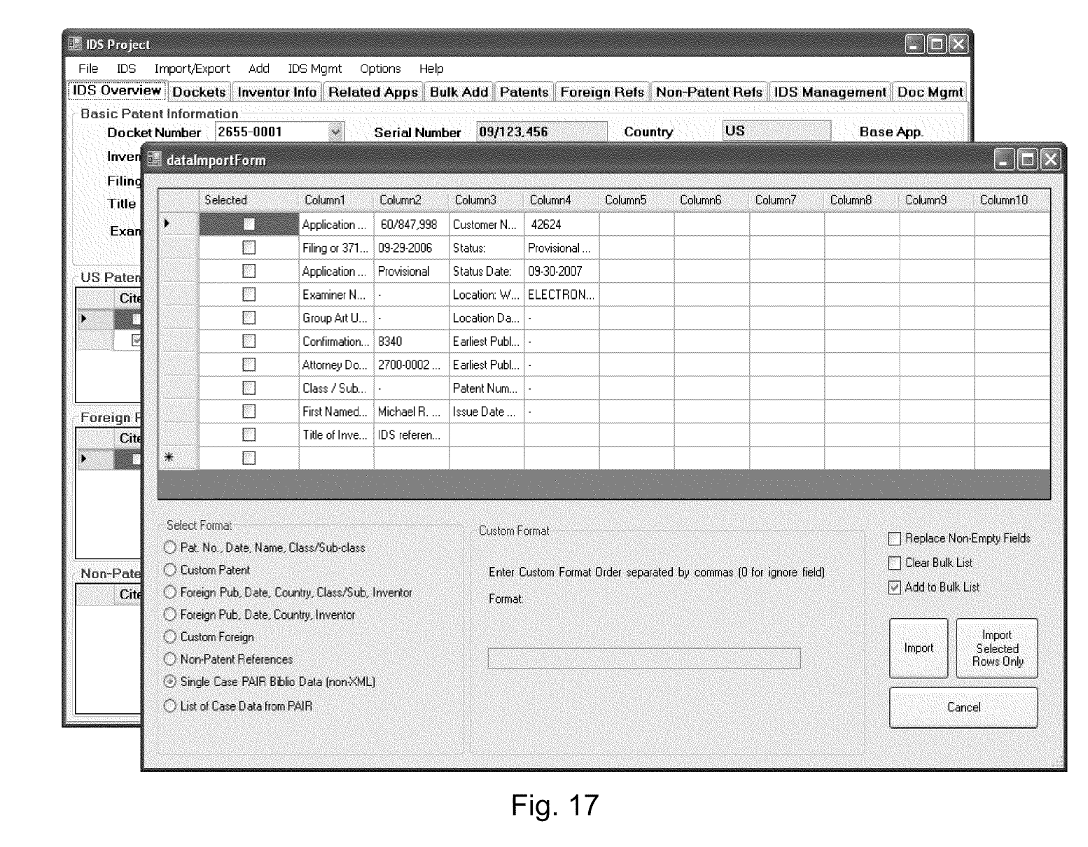

Information about cases can also be obtained from spreadsheets and the like by cutting and pasting columns of data from the spreadsheet into the clipboard where it is then imported. Information could also be obtained from the PAIR system by parsing XML files corresponding to one or more cases for which the PAIR system maintains information. For example, a list of applications by customer number can be parsed, e.g., from a downloaded XML file, to quickly fill a data repository with information about a practitioner's applications (e.g., pending, issued or abandoned). Similarly, to get other information that is not available in the customer number specific report, the information in the “Application data” screen can be copied to the clipboard and then imported as shown in FIG. 17.

In addition to printing a list of references to be cited, it is possible to construct a system that performs the same IDS submission process that is performed on EFS, but instead uploading the non-patent references listed in an IDS. The system would have to be able to access the proaticioner's EFS certificate, but the automated system would aid in reducing the IDS preparation and submission time.

By maintaining a list of which patent applications are related, one can push or pull references into a case from its related cases. The user can then request that a list of all previously uncited references be generated or a list of all presently cited references that have not already been cited in a parent application or an ancestor application. Alternatively, the system can utilize the list of established relationships between cases to automatically push a cited reference to all related cases when it is added to a case.

After references have been cited, the system can be used to generate an IDS that includes all previously uncited references or all previously uncited references except those that were already cited in a parent application. Having generated the IDS that lists all of the references to be considered, the system may track the data on which the IDS was generated. Later, when an examiner has considered the references in the IDS, then the system can be used to mark as considered (or cited) all the references considered by the examiner.

While certain configurations of structures have been illustrated for the purposes of presenting the basic structures of the present invention, one of ordinary skill in the art will appreciate that other variations are possible which would still fall within the scope of the appended claims.

1. A computer system for tracking references to be cited in a pending patent application, a processor of the computer system controlled by computer code in a computer readable medium accessible by the computer system, the system comprising:
computer code for tracking bibliographic information about plural docket entries corresponding to plural patent applications;
computer code for tracking relationship information about the plural docket entries corresponding to the plural patent applications;
computer code for tracking bibliographic information about US patent references, foreign patent references and non-patent references;
computer code for associating a portion of the bibliographic information about US patent references, foreign patent references and non-patent references with a first docket entry of the plural docket entries; and
computer code for utilizing the tracked relationship information about the first docket entry to automatically determine which of the other plural docket entries should also be associated with the portion of the bibliographic information about US patent references, foreign patent references and non-patent references that was associated with the first docket entry and associating that portion of the bibliographic information with those other plural docket entries; and
computer code for importing historical information about references cited in previously issued patents from at least one of a computer clipboard and an XML file.
